(19) United States
(12) Patent Application Publication
(10) Pub. No.: US 2009/0023121 A1
(43) Pub. Date: Jan. 22, 2009

(54) Word problem solving apparatus

(76) Inventor: Xu-Shen Zhou, Whitesboro, NY (US)

Correspondence Address: DAVID GIGLIO, ESQ., 231 ELIZABETH STREET, UTICA, NY, 13501, US

(21) Appl. No.: 11/828,000

(22) Filed: Jul. 16, 2007

(51) Int. Cl. G09B 19/02

(52) U.S. Cl. 434/188

(57) ABSTRACT

The present invention provides a method and apparatus which assists a student in their approach and understanding to solving algebraic word problems. The invention includes a predetermined set of word problems. The student solves the word problem by selecting appropriate rate bars which are responsive to a selected word problem and placing the selected rate bars in proper placement with respect to a measurement line. The student also selects the proper equation, which also includes pre-solved solutions for the selected word problem. The student thus solves the problem through the use of the rate bars alone or in conjunction with a parallel solution provided in the pre-solved equation.

### FIELD OF THE INVENTION

The present invention relates generally to the field of word problems and, more particularly, to an apparatus and method for assisting a student with understanding how to approach and solve word problems with the assistance of the sense of touch.

### BACKGROUND OF THE INVENTION

Many students have a difficult time solving word problems. In the universities, students are generally taught problem solving through various methods and apparatus. The most obvious is the lecture and text book method. A student is assigned to read a chapter and asked to solve problems at the end of the chapter. After reading the chapter, many students will look back through the chapter for various formulae and attempt to apply those formulae to word problems.

In conjunction with this, a teacher will also give a lecture on the subject in which the student may take notes, including various formulae, and also use the notes to help solve the word problems. Thus, a particular subject should now contain one set of formulae in the text book and another set in the students notebook, preferably the same set as in the text book.

Usually teachers do not have enough time in class to show more examples and students do not have enough time to practice more examples at home. There is also a problem of remembering what was said so that the classroom notes often don't make sense to many students.

In particular, solving algebraic word problems has always been a challenge for many students. The challenge arises because of several problems. Often, the students do not know how to begin. Also, they have a difficult time translating English words into x and y variables and algebra equations, which by themselves are difficult for many students to solve. Even after solving the problems by following examples and procedures given in the textbook or by the teachers, they do not understand the nature of the problems well. This results in their inability to solve new problems which reflects in high course grades but low standardized test scores.

One additional problem with the traditional teaching method is that the student will not actually touch the formulae. He or she will have seen and written the formulae, but will have not actually touched or otherwise manipulated the formula.

In terms of sense of touch, muscle memory and hand-brain coordination are an integral component of sports training, which is traced back to human beings learning abilities developed over millions of years of evolution. As Confucius once prophesied:

“I hear and I forget

I see and I remember

I do and I understand.”

Another problem with the traditional teaching method is that a calculator is still required to solve the problems which is time consuming and requires extra equipment. Many students have problems starting and setting up word problems for several reasons. First, they often have a hard time deciding which formulae to choose. Also, they have a hard time reading which results in not quite understanding the book and how to use the formulae.

Yet still a problem arises because many students do not understand how to enter distribution into a calculator for a particular complex formula. Even when such calculation are performed through a calculator there is much writing and manipulating which results in a majority of time being wasted performing calculations.

### SUMMARY AND OBJECTS OF THE PRESENT INVENTION

It is an object of the present invention to improve the art of teaching and learning.

It is another object of the present invention to provide an apparatus and method for teaching and understanding an approach to solving word problems.

It is another object of the present invention to use the sense of touch to help students understand and improve word problems.

It is a further object of the present invention to teach student to focus on the general methods of solving word problems rather than in performing calculations.

It is yet a further object of the present invention to reduce the time for calculations so that more problems are practiced during a given time.

It is yet another object of the present invention to transform word problems into easily understood forms that students can see, touch and control.

It still another object of the present invention to teach a student to solve word problems without using a writing implement or without solving equations.

It is yet still a further object of the present invention to boost a student's confidence in maths in general and word problems in particular with the use of an easy, fast and sensible approach.

It is a feature of the present invention to link word problems with algebraic variables and equations so that students can work with the problems in abstract form and enhance their abstract thinking abilities.

It is another feature of the present invention to present a preset, calculated and solved set of problems so that students can practice many algebra problems in a short period of time.

It is a further feature of the present invention to present word problems in a puzzle type of format so that students can use a trial and error strategy.

It is still another object of the present invention to provide intuitive pictures and graphics on printed movable cards.

It is a feature of the present invention to provide a predetermined set of word problems, a solution surface and a predetermined set of rate bars that are used to solve the predetermined set of word problems.

These and other objects and features of the present invention are provided in accordance with the present invention in which there is provided a teaching apparatus for assisting a student's approach and understanding to solving word problems. The apparatus includes a predetermined set of word problems, in which a selected word problem includes at least one independent variable having a predetermined known value and at least one dependent variable which is dependent on the independent variable.

The apparatus includes a work board which has a measurement line on its obverse surface. The measurement line includes a forward unit line which has predetermined spaced intervals each indicative of a single unit.

The apparatus further includes a predetermined set of movable rate bars which are responsive to the predetermined set of word problems. Each of the rate bars also includes predetermined rate interval indicia disposed thereon. The rate bars are adjustable with respect to the measurement line.

The apparatus also includes a predetermined set of movable formulae which are responsive to the predetermined set of word problems. In one embodiment the movable formulae further include pre-solved steps to show the solution to a particular word problem.

In a preferred embodiment the measurement line also includes a reverse unit line having predetermined spaced intervals representative of the measured units of the word problem. The reverse unit line and forward unit line increase in magnitude in opposing directions.

The rate bars also include reverse unit lines so that rate may be determined in a reverse direction.

In another preferred embodiment, the measurement line is movable to accommodate word problems in which different units need to be solved for.

In a preferred embodiment, the work board, the measurement line, rate bars and equations are all magnetic.

The present invention is adaptable to accommodate word problems from many different fields.

### BRIEF DESCRIPTION OF DRAWINGS

The present invention will be understood and appreciated more fully from the following detailed description taken in conjunction with the drawings in which:

FIG. 1 is a top view of rate bars showing time and distance at rates of between twenty miles per hour up to sixty miles per hour, at intervals of ten miles per hour in accordance with an embodiment of the present invention;

FIG. 2 is a top view of a work board in accordance with an embodiment of the present invention;

FIG. 3 is a top view of the work board of FIG. 2 showing a solution of a first velocity rate sample problem in accordance with an embodiment of the present invention;

FIG. 4 is a top view of the work board of FIG. 2 showing a solution of a second velocity rate sample problem in accordance with an embodiment of the present invention;

FIG. 5 is a top view of depicting various work rate bars in accordance with the present invention;

FIG. 6 is a top view of a work board showing a solution for a sample work rate problem in accordance with an embodiment of the present invention;

FIG. 7 is a top view depicting various coinage rate bars in accordance with an embodiment of the present invention;

FIG. 8 is a top view depicting the solution of a coinage rate word problem in accordance with an embodiment of the present invention;

FIG. 9 is a top view of various moment arm rate bars in accordance with an embodiment of the present invention.

FIG. 10 is a top view depicting a solution of a moment arm rate problem in accordance with an embodiment of the present invention;

FIG. 11 is a top view of various mixture rates in accordance with an embodiment of the present invention; and

FIG. 12 is a top view depicting a solution of a mixture rate word problem in accordance with an embodiment of the present invention.

### DETAILED DESCRIPTION OF A PREFERRED EMBODIMENT

The present invention will now be described in accordance with a preferred embodiment pertaining to time, distance, and rate type subject matter. It will become apparent to one skilled in the art of teaching that the application of the present invention may also be used in other areas of study pertaining to subject matter having algebraic word problems.

Distance is determined using known values for rate and time. Values for distance are measured in miles. The value for distance is calculated using the formula:

distance=rate*time

d is the total distance of the trip. r is the average rate the object traveled to cover d, and is measured in miles per hour. t is the total time the object took to travel distance d, and is measured in hours. Values of distance, time, or rate, for specific intervals of intermittent travel, are determined using formulae:

d=d1+d2

d1=r1*t1

d2=r2*t2

d1 is a measure of the distance traveled in the first interval of distance d. t1 is a measure of the time it takes to travel the distance of d1. r1 is a measure of the average rate the object traveled during t1. d2 is a measure of the distance traveled in the second interval of d. t2 is a measure of the time it takes to travel the distance of d2. r2 is a measure of the average rate the object traveled during t2.

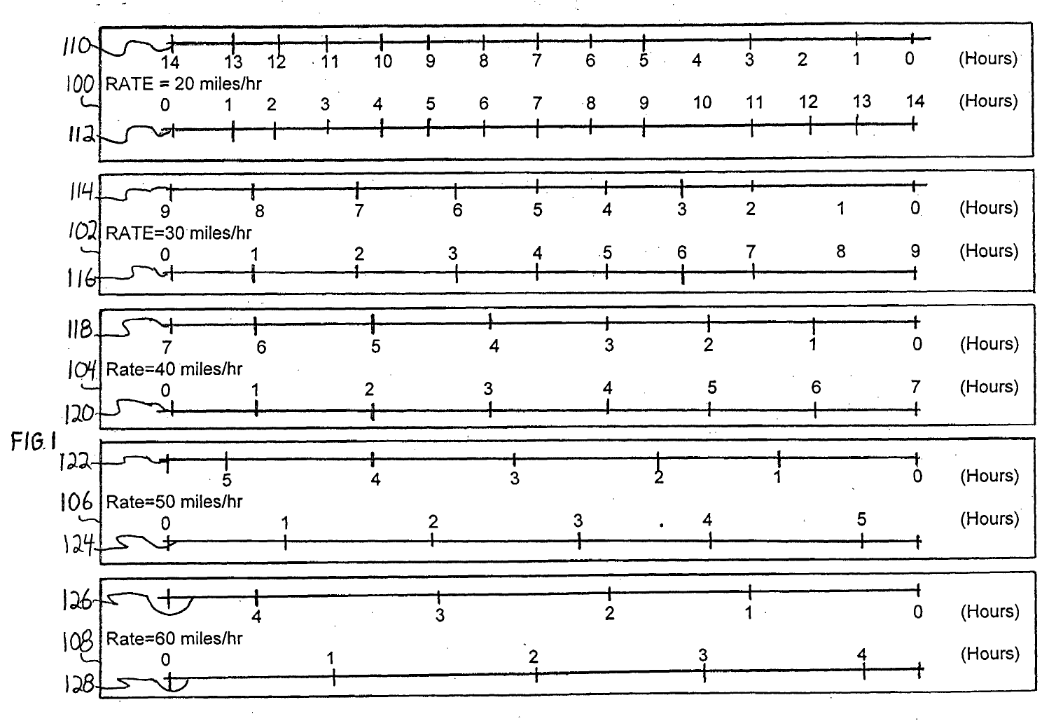

Turning now to FIG. 1, there is depicted a finite series of rate bars each having an independent predetermined rate for a predetermined sample problem set pertaining to velocity based algebraic word problems.

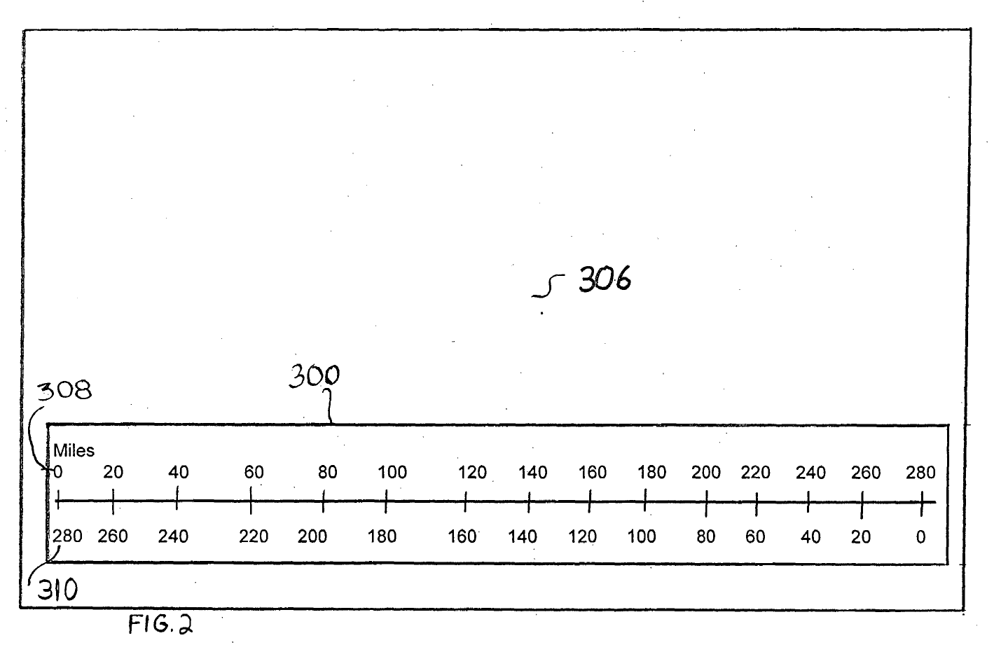

A twenty mile per hour rate bar 100 depicts distance as measured by rate and time in perspective to a distance line 300 depicted in FIG. 2 at twenty miles per hour. A forward direction time line 112 shows distance traveled in a forward direction at twenty miles/Hour over a predetermined range of time, wherein the distances are spaced by equidistant intervals according to the duration of time traveled. Forward direction time line 112 on twenty mile per hour rate bar 100 begins at zero denoting the time the object begins to move forward at a rate of twenty miles per hour. Each subsequent hash-mark on forward direction time line 112 represents the distance traveled at six-minute intervals with respect to distance line 300. The specific hours are labeled and continue sequentially through a predetermined term of up to fourteen-hours. A reverse direction time line 110 shows the distance traveled in a direction opposite to forward direction time line 112, at a rate of twenty miles per hour. Reverse direction time line 110, on twenty mile per hour rate bar 100, begins at the zero hour and traverses through fourteen hours of travel in the opposite direction with distance traveled, at six-minute intervals, represented by each hash-mark.

A thirty mile per hour rate bar 102 depicts distance as measured by rate and time in perspective to a distance line 300 depicted in FIG. 2 at thirty miles per hour. A forward direction time line 116 shows distance traveled in a forward direction at thirty miles per hour over a predetermined range of time, wherein the distances are spaced by equidistant intervals according to time traveled. Forward direction time line 116 on thirty mile per hour rate bar 102 begins at zero denoting the time the object begins to move forward at a rate of thirty miles per hour. Each subsequent hash-mark on forward direction time line 116 represents the distance traveled in four-minute intervals with respect to distance line 300. The specific hours are labeled and continue sequentially through a predetermined term of up to nine-hours twenty-minutes. A reverse direction time line 114 shows distance traveled in a direction opposite to forward direction time line 1 16, at a rate of thirty miles per hour.

A forty mile per hour rate bar 104 depicts distance as measured by rate and time in perspective to a distance line 300 depicted in FIG. 2 at forty miles per hour. A forward direction time line 120 shows distance traveled in a forward direction at forty miles/Hour over a predetermined range of time, wherein the distances are spaced by equidistant intervals according to time traveled with respect to distance line 300. Forward direction time line 120, on forty mile per hour rate bar 104, begins at zero denoting the time the object begins to move forward at a rate of forty miles per hour. Each subsequent hash-mark on forward direction time line 120 represents three-minute intervals. The specific hours are labeled and continue sequentially through a predetermined term of up to seven-hours. A reverse direction time line 118 shows distance traveled in a direction opposite to forward direction time line 120, at a rate of forty miles/Hour.

A fifty mile per hour rate bar 106 depicts distance as measured by rate and time in perspective to a distance line 300 depicted in FIG. 2 at fifty miles per hour. A forward direction time line 124 shows distance traveled in a forward direction at fifty miles per hour over a predetermined range of time, wherein the distances are spaced by equidistant intervals according to time traveled. Forward direction time line 124, on fifty mile per hour rate bar 106, begins at zero denoting the time the object begins to move forward at a rate of fifty miles per hour. Each subsequent hash-mark on forward direction time line 124 represents the distance traveled in successive two-minute twenty-four-second intervals with respect to distance line 300. The specific hours are labeled and continue sequentially through a predetermined term of up to five-hours thirty-six-minutes. A reverse direction time line 122 shows distance traveled in a direction opposite to forward direction time line 124, at a rate of fifty miles/Hour.

A sixty mile per hour rate bar 108 depicts distance as measured by rate and time in perspective to a distance line 300 depicted in FIG. 2 at sixty miles per hour. A forward direction time line 128 shows distance traveled in a forward direction at sixty miles per hour over a predetermined range of time, wherein the distances are spaced by equidistant intervals according to time traveled. Forward direction time line 128, on sixty mile per hour rate bar 108, begins at zero denoting the time the object begins to move forward at a rate of sixty miles per hour. Each subsequent hash-mark on forward direction time line 128 represents the distance traveled in successive two-minute intervals with respect to distance line 300. The specific hours are labeled and continue sequentially through a predetermined term of up to four-hours forty-minutes. A reverse direction time line 126 shows distance traveled in a direction opposite to forward direction time line 128, at a rate of sixty miles per hour.

Turning now to FIG. 2, a work board 306 is depicted, which includes distance line 300 10 imprinted thereon in which a predetermined number of consecutive integers are equidistantly spaced. Alternatively, the distance line may also be movable so that a single work board 306 accommodates various measurement lines.

A forward distance line 308, on distance line 300, starts at zero denoting the point of origin and continues through a pre-selected term of two-hundred eighty miles. Each hash-mark represents a distance of two miles from the origin to the destination, and every twenty miles is identified. A reverse distance line 310, on distance line 300, measures distance from the destination to the origin. Once again, each hash-mark represents a distance of two miles, and every twenty miles is identified.

The magnetic feature of work board 306 allows for the rate bars, formulae and pre-solved solutions to be temporarily affixed in the appropriate areas on work board 306 in order to easily solve predetermined distance problems. An advantage to the magnetic feature of work board 306 is the ability to conveniently remove and add different formulae and rate bars with respect to the distance line and not have any slippage. The direct placement of the rate bars with respect to the distance line allows the student to manually manipulate and to visualize a solution.

The present invention pertaining to distance problems will now be described according to a number of examples. The first example is a word problem in which a student determines the time and distance traveled during the second interval of a trip that covers a total distance of two-hundred eighty miles. The first interval of the trip is accomplished in a time of two hours, moving at a rate of sixty miles/Hour. The second interval is accomplished at a rate of forty miles per hour and the student is asked to determine the length of time and the distance of the second interval of travel.

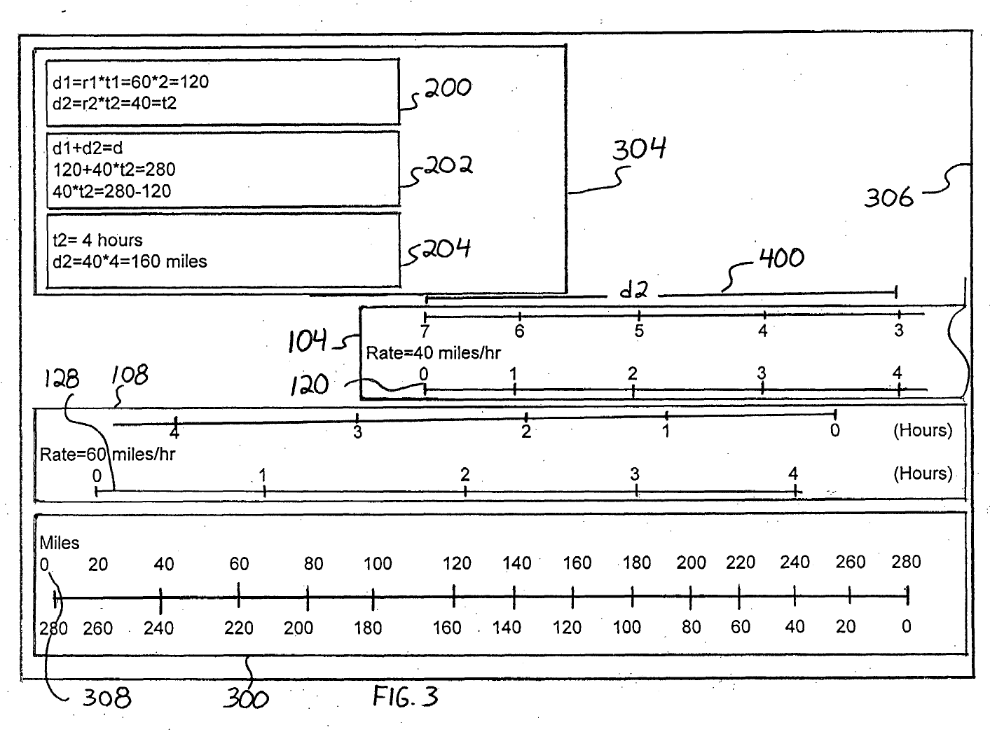

Referring now to FIG. 3, there is depicted a solution in accordance with the present invention in which distance is determined for a second interval distance 400 of intermittent travel rates. The first interval of the trip is accomplished in a time of two hours at a rate of sixty miles per hour. Thus the student selects the sixty mile per hour rate bar 108 and places the sixty mile per hour rate bar 108 above the forward distance line 308 on work board 306 so that the zero on the sixty mile per hour rate bar 108 and the zero on forward distance line 308 align. The distance traveled in the first interval is easily determined by looking at the hours traveled on sixty mile per hour rate bar 108, and the corresponding aligned distance on forward distance line 308.

Second interval distance 400 is accomplished at a rate of forty miles per hour, from hour two until arrival at the destination. Thus the student selects the forty mile per hour rate bar 104 and places forty mile per hour rate bar 104 on work board 306 above forward distance line 308 and sixty mile per hour rate bar 108. The student places forty mile per hour rate bar 104 so that the zero on forward direction time line 120, the two-hour mark on forward direction time line 128, and the one-hundred-twenty mile mark on forward distance line 308 align. The distance traveled in second interval distance 400 is easily determined by looking at the distance traveled on forward distance line 308 during second interval distance 400. The time it takes to travel second interval distance 400 is easily determined by looking at the hours traveled on forward direction time line 120, during second interval distance 400.

A selected initial formula 200 is placed in formula placement area 304 on work board 306. This allows the student to conveniently identify how the formulae are utilized to determine the distance traveled during a particular interval of an intermittent trip. The value for d1 is determined by multiplying the known values for r1 and t1, as depicted in formula 200. In this example, (r1) 60 miles per hour is multiplied by (t1) two hours to arrive at a value of (d1) 120 miles. As depicted in an intermediate solution formulae 202 the value for d is equal to the sum of d1 and d2, or r1*t1 and r2*t2. In this word problem the student determines (d2) the distance traveled during second interval distance 400 and (t2) the time it takes to travel second interval distance 400. The value for d2, depicted in a solution step 204, is determined by subtracting the known value for d1 from the known value for d, as depicted in intermediate formulae 202. In this example, (d1) 120 miles is subtracted from (d) 280 miles to arrive at a value of (d2) 160 miles. The value for t2 is determined by dividing the known value of d2 by the known value for r2, as depicted in solution step 204. In this example, (d2) 160 miles is divided by (r2) 40 miles per hour to arrive at a value of (t2) four hours.

In the above example, the initial formula 200, the intermediate formula 202 and the solution step 204 are all contain different background colors. In a preferred embodiment of the present invention, there will be a predetermined set of word problems for a particular subject matter. Each word problem has a corresponding initial formula of a first color, an intermediate formula of a second color and a solution step of a third color. The user must then correctly select one of each color to find the overall solution.

The next example is a word problem involving two cars moving towards each other. In this example a student determines the time elapsed when the two cars will meet.

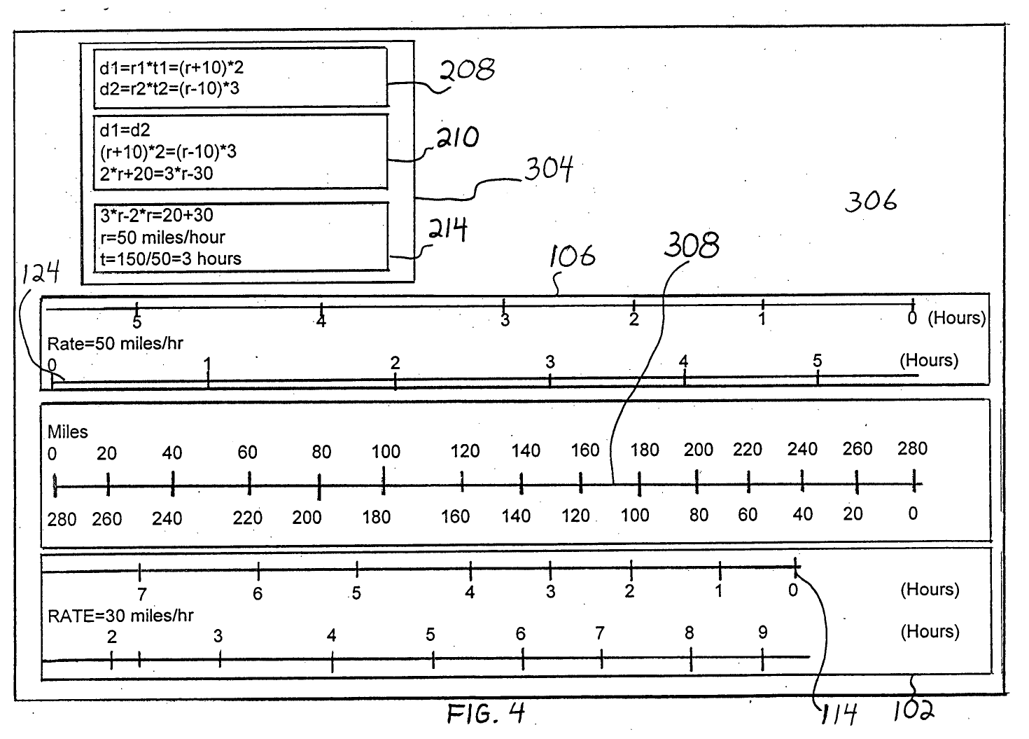

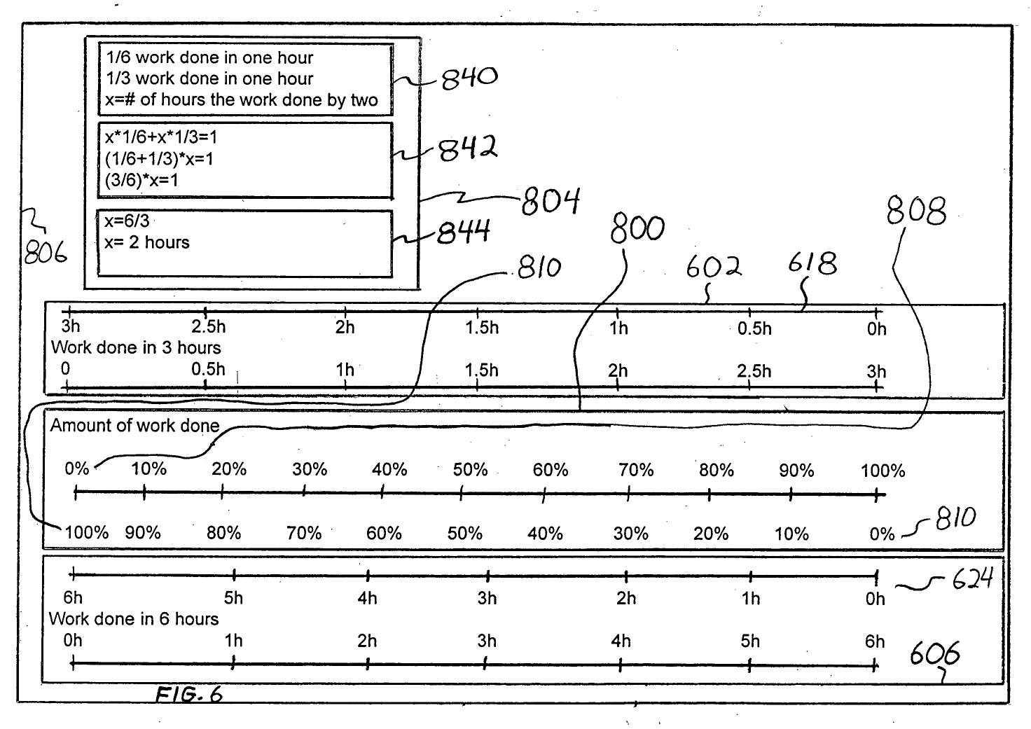

Referring now to FIG. 4, there is depicted a solution, in accordance with the present invention, for the elapsed time when two cars meet. The two cars at opposite ends of a straight road, with a distance of two-hundred-forty miles, begin moving towards each other at the same time. The first car begins at “Point-A”, moving towards “Point B” at a rate of fifty miles/Hour. Thus the student selects fifty mile per hour rate bar 106 and places fifty mile per hour rate bar 106 above forward distance line 308, on work board 306, so the zero on forward direction time line 124 and the zero on forward distance line 308 align. The second car begins at “Point-B”, moving towards “Point A” at a rate of thirty miles/Hour. Thus the student selects thirty mile per hour rate bar 102 depicting travel at thirty miles/Hour and places thirty mile per hour rate bar 102 below reverse distance line 310, on work board 306, so the zero on reverse direction time line 114 and the two-hundred-forty mile mark on forward distance line 308 align. The point in which the time measured on forward direction time line 124 and reverse direction time line 114 are the equal, represents the appropriate value for time elapsed when the two cars meet. For this example, the value for time measured on forward direction time line 124 and reverse direction time line 114, is equal at three hours. The student easily determines the cars meet at a time of three hours, as depicted in FIG. 6.

An initial formula 208 and an intermediate formula 210 are selected and placed in formula placement area 304, on work board 306. This allows the student to conveniently identify how the formulae are utilized in determining the time when the cars meet.

In this word problem the student must determine (t) the elapsed time when the two cars meet. The value for t is determined by dividing the known value for d by the sum of the r1 and r2, as depicted in formulae 208 and 210. In this example, (d) two-hundred-forty miles is divided by the sum of (r1) fifty miles/Hour and (r2) thirty miles/Hour to arrive at a value of (t) three hours, shown in a solution step 214.

Work Rate Problems

The present invention will now be described in accordance with a preferred embodiment pertaining to amount of work done, the rate that work is done, and time worked. It will become apparent to one skilled in the art of teaching that the application of the present invention may also be used in other areas of study pertaining to subject matter having word problems.

The amount of work accomplished is determined using known values for rate that work is done, and the time worked. Values for time worked are measured in hours. The value for amount of work done is calculated using the formula:

The amount of work accomplished equals the rate that work is done multiplied by the amount of time worked where:

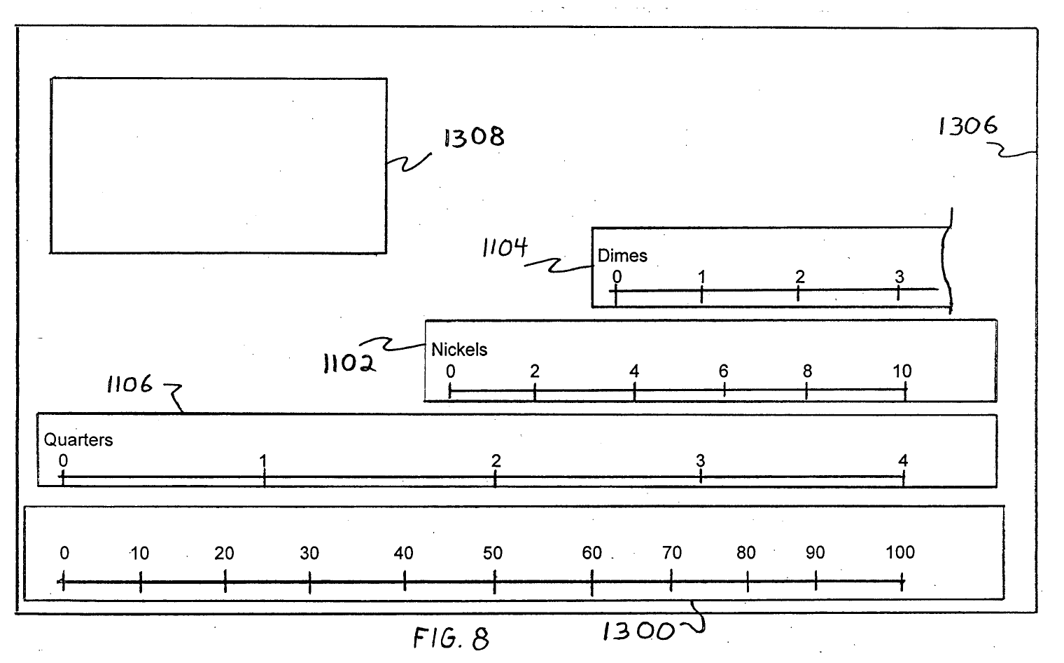

W is the total amount of work done. r is the average rate that work is done, and is measured in work done/Hour. For example, where it takes an individual five hours to complete a specific task then the rate is ⅕ of the task per hour. t is the total time worked to complete a specific task, and is measured in hours. Values of amount of work done, the rate that work is done, and time worked for specific intervals, are determined using formulae from FIG. 8:

W=W1+W2

W1=r1*t1

W2=r2*t2

W1 represents the quantity of work accomplished during a first time interval (t1) for a specific task. r1 is a measure of the average rate that work is done during t1. W2 represents the quantity of work done during a second time interval (t2) for the specific task. r2 represents the average rate that work is done during t2.

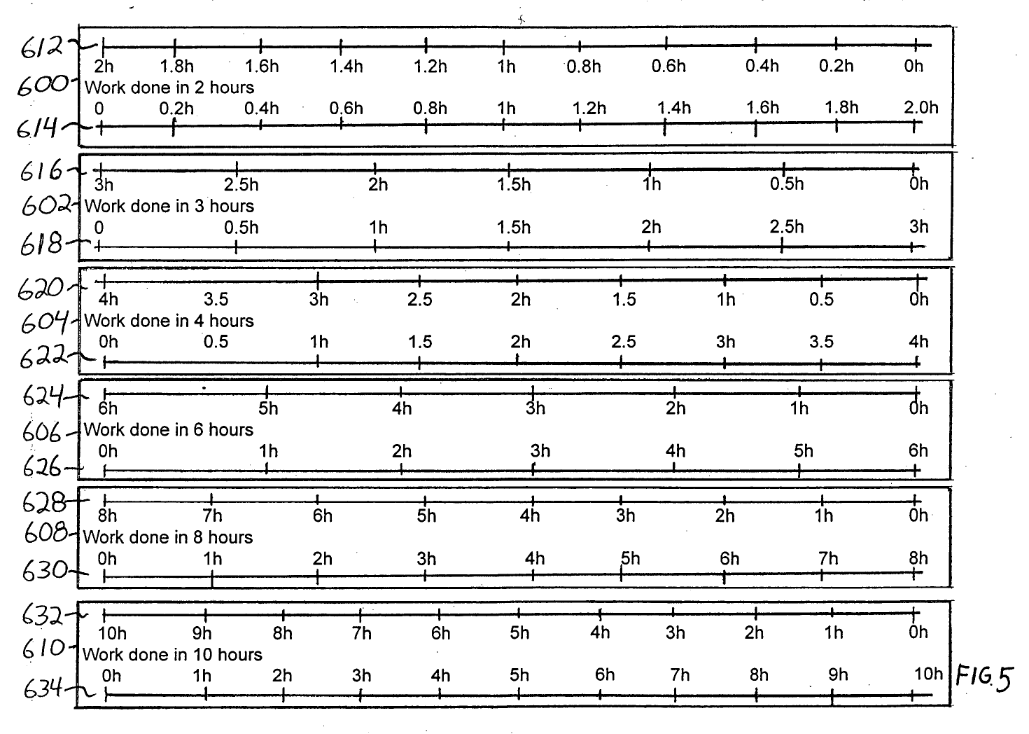

Turning now to FIG. 5, there is depicted a finite series of work rate bars each having an independent predetermined rate.

A two hour work rate bar 600 depicts amount of work done as measured by rate and time at rate requisite to complete a task in two hours. A two hour work time line 614 shows the percentage amount of work which is accomplished at specific times for a task which is to be completed in two hours with respect to a working percentage line 800,-depicted in FIG. 6. Each successive hash-mark on two hour work time line 614 represents the percentage of work accomplished in one-minute twelve-second intervals. The specific times are labeled at every twelve minutes and continue sequentially through a predetermined term of up to two hours. A reverse two hour work time line 612 indicates the percentage of negative work accomplished at a rate of completely undoing a task in two hours.

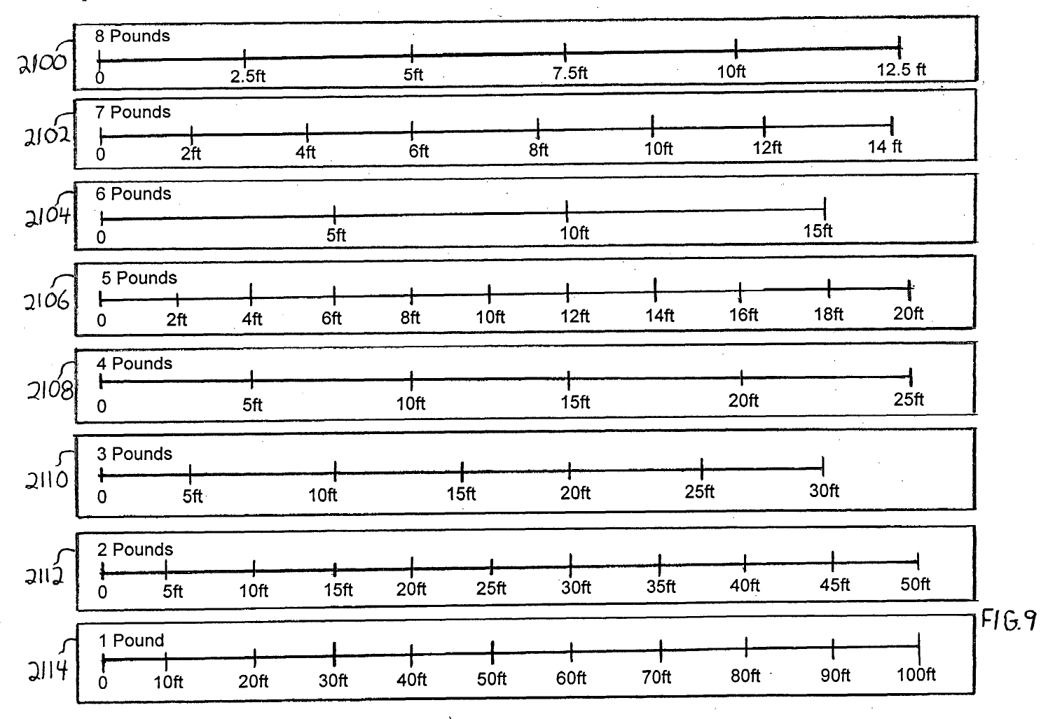

A three hour work rate bar 602 depicts amount of work done as measured by rate and time at rate requisite to complete a task in three hours. A three hour work time line 618 shows the percentage amount of work which is accomplished at specific times for a task which is to be completed in three hours with respect to a working percentage line 800, depicted in FIG. 9. Each successive hash-mark on three hour work time line 618 represents the percentage of work accomplished in one-minute forty-eight-second intervals. The specific times are labeled at every thirty minutes and continue sequentially through a predetermined term of up to three hours. A reverse three hour work time line 616 indicates the percentage of negative work accomplished at a rate of completely undoing a task in three hours.

A four hour work rate bar 604 depicts amount of work done as measured by rate and time at rate requisite to complete a task in four hours. A four hour work time line 622 shows the percentage amount of work which is accomplished at specific times for a task which is to be completed in four hours with respect to a working percentage line 800, depicted in FIG. 9. Each successive hash-mark on four hour work time line 622 represents the percentage of work accomplished in two-minute twenty-four-second intervals. The specific times are labeled at every thirty minutes and continue sequentially through a predetermined term of up to four hours. A reverse four hour work time line 620 indicates the percentage of negative work accomplished at a rate of completely undoing a task in four hours.

A six hour work rate bar 606 depicts amount of work done as measured by rate and time at rate requisite to complete a task in six hours. A six hour work time line 626 shows the percentage amount of work which is accomplished at specific times for a task which is to be completed in six hours with respect to a working percentage line 800, depicted in FIG. 9. Each successive hash-mark on six hour work time line 626 represents the percentage of work accomplished in three-minute thirty-six-second intervals. The specific times are labeled at every one hour and continue sequentially through a predetermined term of up to six hours. A reverse six hour work time line 624 indicates the percentage of negative work accomplished at a rate of completely undoing a task in six hours.

An eight hour work rate bar 608 depicts amount of work done as measured by rate and time at rate requisite to complete a task in eight hours. An eight hour work time line 630 shows the percentage amount of work which is accomplished at specific times for a task which is to be completed in eight hours with respect to a working percentage line 800, depicted in FIG. 9. Each successive hash-mark on eight hour work time line 630 represents the percentage of work accomplished in four-minute forty-eight-second intervals. The specific times are labeled at every one hour and continue sequentially through a predetermined term of up to eight hours. A reverse eight hour work time line 628 indicates the percentage of negative work accomplished at a rate of completely undoing a task in eight hours.

A ten hour work rate bar 610 depicts amount of work done as measured by rate and time at rate requisite to complete a task in ten hours. A ten hour work time line 634 shows the percentage amount of work which is accomplished at specific times for a task which is to be completed in ten hours with respect to a working percentage line 800, depicted in FIG. 9. Each successive hash-mark on ten hour work time line 634 represents the percentage of work accomplished in six minute intervals. The specific times are labeled at every one hour and continue sequentially through a predetermined term of up to ten hours. A reverse ten hour work time line 632 indicates the percentage of negative work accomplished at a rate of completely undoing a task in ten hours.

Turning now to FIG. 6, a work board 806 is depicted, which includes working percentage line 800 imprinted thereon in which a predetermined interval of percentages, measuring up to one-hundred percent of work necessary to complete a specific task, are equidistantly spaced. A forward working percentage line 808 measures the amount of work accomplished in terms of percent for completing a specific task. The forwarding working percentage line 808 starts at zero denoting the point where no work has been done and continues through a pre-selected term of one-hundred percent. Each hash-mark represents one percent of work done towards completion of the work, and every ten percent is identified.

A reverse percentage line 810, also on percentage line 800 represents the amount of negative work done, which in certain problems actually slows the progress of work performed in completing the specific task.

The appropriate formulae are selected and placed on work board 806 in a formula placement area 804, as depicted in FIG. 6. The corresponding work rate bars, from FIG. 5, are placed on working surface member 802 above working percentage line 800, as depicted in FIG. 6.

In one example, it is necessary to determine how long it takes two individuals working together to complete a specific task, where a first individual working alone can complete the task in six hours and second individual working alone can complete the task in three hours.

Turning to FIG. 6, the student selects three hour work rate bar 602 and places the three hour work rate bar above the working percentage line 800 so that the zero on the three hour work time line 618 and the zero on the forward working distance line 808 align. Next, the student selects the six hour work rate bar 606 and places it below the working percentage line 800 so that the zero on the reverse six hour work time line 624 and the zero on the reverse working percentage line 800 align.

Next, the user sights where the time elapsed on the three hour work time line 618 and reverse six hour work time line 624 are that same for a single point along the working percentage line 800. Looking at FIG. 6 the point at which the work will be completed by the two individuals working together is 2.0 hours. Thus, the user visualizes that to solve the problem, simultaneous equations for work are required and the solution exists where t1 and t2 are equal.

Therefore, for the three hour work rate, work W1=r1*t1, where r1=⅓. For the six hour reverse work rate, Work W2=r2*t2 where r2=⅙. Since t1=t2=t (time elapsed to completion), W1=t/3 and W2=t/6. W1+W2=1 since the total work of the two individuals equals one specific task. Thus, t/3+t/6=1. As a result, the total time t that it takes the two individuals to complete the specific task is 2 hours.

An initial formula 840, an intermediate formula 842 and a solution step 844 are placed in the in the formula placement area 804 of the work board 806 so that the user solves the predetermined word problem while visualizing the solution with the work rate bars, depicted in FIG. 6.

COIN RATES

The present invention will now be described in accordance with a preferred embodiment pertaining to predetermined values of money and different types of coins. In the example presented herein, the value for the amount of money is measured is cents. Values for the types of coins are measured in combinations of pennies, nickels, dimes, and quarters. Pennies are equal to one-cent, nickels are equal to five-cents, dimes are equal to ten-cents, and quarters are equal to twenty-five-cents. The value for the total amount of money is calculated using the formula:

total amount of money=Σ the coins

M is the total amount of money. x is represents one-cent, and each type of coin is represented by the product of x and the amount of cents a coin represents. Thus x represents a penny, 5x represents a nickel, 10x represents a dime, and 25x represents a quarter. Values for the number of each type of coins used for specific amounts of money, and the total amount of money is determined in accordance with the formula:

M=Σx

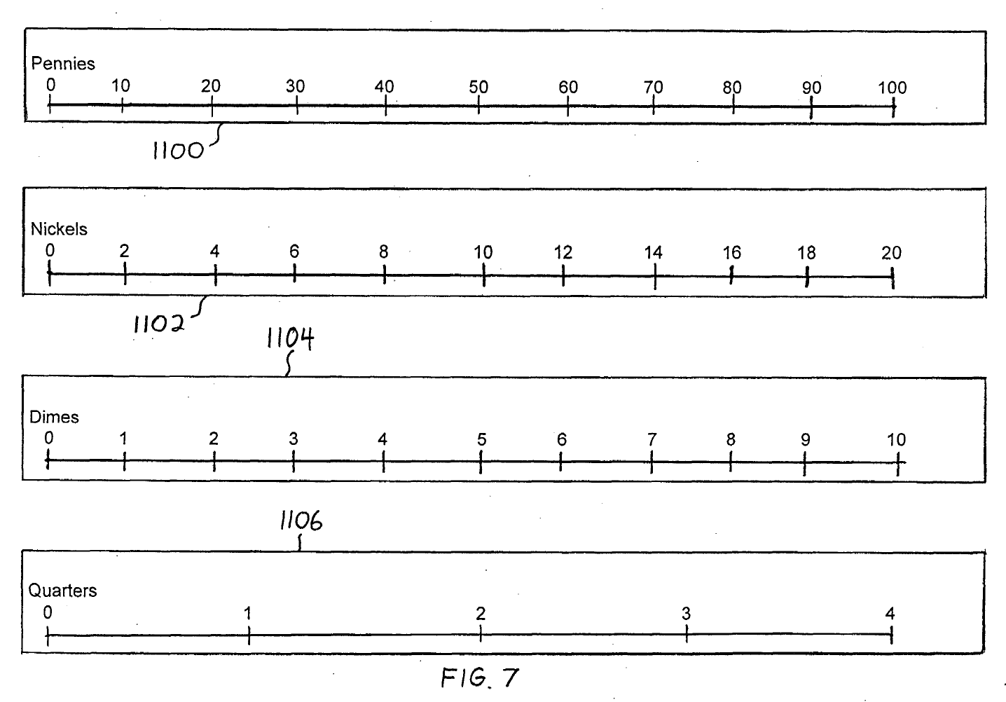

Turning now to FIG. 7, there is depicted a finite series of money rate bars each having an independent predetermined rate.

A penny rate bar 1100 depicts the amount of money at a penny rate at equidistant spaced intervals up to one hundred pennies or one dollar. The specific amounts of pennies are labeled at every ten pennies.

A nickel rate bar 1102, shown in FIG. 7, depicts the a rate of nickels that is required to achieve one dollar along the money line 1300, depicted in FIG. 8. The specific quantity of nickels are labeled, at every two Nickels and continue sequentially through a predetermined term of twenty nickels, or one-dollar.

A dime rate bar 1104, shown in FIG. 7, depicts the rate of dimes that is required to achieve one dollar along the money line 1300, depicted in FIG. 8. The specific quantity of dimes are labeled, at every one dime, and continue sequentially through a predetermined term of ten dimes, or one-dollar.

A quarter rate bar 1106, shown in FIG. 7, depicts the rate of dimes that is required to achieve one dollar along the money line 1300, depicted in FIG. 8. The specific amounts of quarters are labeled at every one quarter, and continue sequentially through a predetermined term of four quarters, or one-dollar.

Turning now to FIG. 8, a work board 1306 is depicted, which includes money line 1300 thereon. Money line 1300 allows the student to measure sums of different coin types using equidistant spaced intervals that start at zero and measuring up to one-hundred cents. Each hash-mark represents one cent, and every ten cents is identified. The work board 1306 further includes an equation area 1308 in which the student places equations and any pre-solved solutions.

Looking now at an application of the present invention in accordance with a predetermined money problem example, it is necessary to determine the quantities of dimes, nickels and quarter that are required to sum one dollar where the number of nickels is twice the number of quarters, and the number of dimes is one less than the number of nickels. In the present application, a trial and error method is used.

Referring to FIG. 8, the user selects the quarter rate bar 1 106 and places the same over the money line 1300 so that the corresponding zeros align. Next, the user selects the nickel rate bar 1102 and places the zero on the nickel rate bar 1102 over the three on the quarter rate bar and checks to determine whether the first condition of the problem is achieved, namely that quantity of nickels is twice the quantity of the quarters. A quick analysis of the total sum of money at this point reveals that there three quarters and six nickels for a sum of $1.05 which is more than one dollar. Thus, the problem of elimination tells us that this is not a correct solution.

Next, the student moves the nickel rate bar 1102 so that the zero on the nickel rate bar is aligned over the two on the quarter rate bar 1106. A quick analysis reveals that the sum of four nickels and two quarter still less than one dollar. The student then places the dime rate bar 1104 over the nickel rate bar 1104 so that zero on the dime rate bar is aligned with the four on the nickel rate bar 1104.

The student then determines whether they have correctly solved the problem with the money rate bars by determining whether the three on the dimes bar aligns with the one dollar on the money line 1300, which would then satisfy the second condition, namely that the quantity of dimes is one less than the quantity of nickels. Since there is an alignment between the three on the dime rate bar 1104 and the one dollar on the money line 1300, the problem has been solved using the money rate bars.

Next, the student looks to the formula (not shown) and places the same in the equation area 1308 and performs a mathematical calculation with one eye on the money rate bars. With this method, the student is able to touch and manipulate the solution, is able to visualize the solution, and is able to relate the equations in accordance with the touch, manipulation and visualization.

MOMENT ARM RATES

The present invention will now be described in accordance with the preferred embodiment pertaining to weights and distance from a fulcrum, for a balanced lever. The values for moments arms are determined in this embodiment, where the moment arm is simply the force multiplied by the distance from a specific point, commonly referred to as a fulcrum .

The weight of an object on either side of the lever and its distance from the fulcrum are determined using known values for weight and distance. Values for weight are measured in pounds, and values for distance are measured in feet. The values for weight or distance are calculated using the formula:

Weight on end of the lever multiplied by the distance from the fulcrum equals the moment arm about the fulcrum or m=w*d, where m is the moment arm, w represents the weight or force of a particular object and d represents the distance of the object from the fulcrum.

Thus to balance the lever on the fulcrum, it is necessary to have the moment arms provided for by two opposing objects to be equal or m1=m2, where m1 is the moment arm of the first object and m2 is the moment arm of the second object.

Thus, the balance the lever: w1*d1=w2*d2

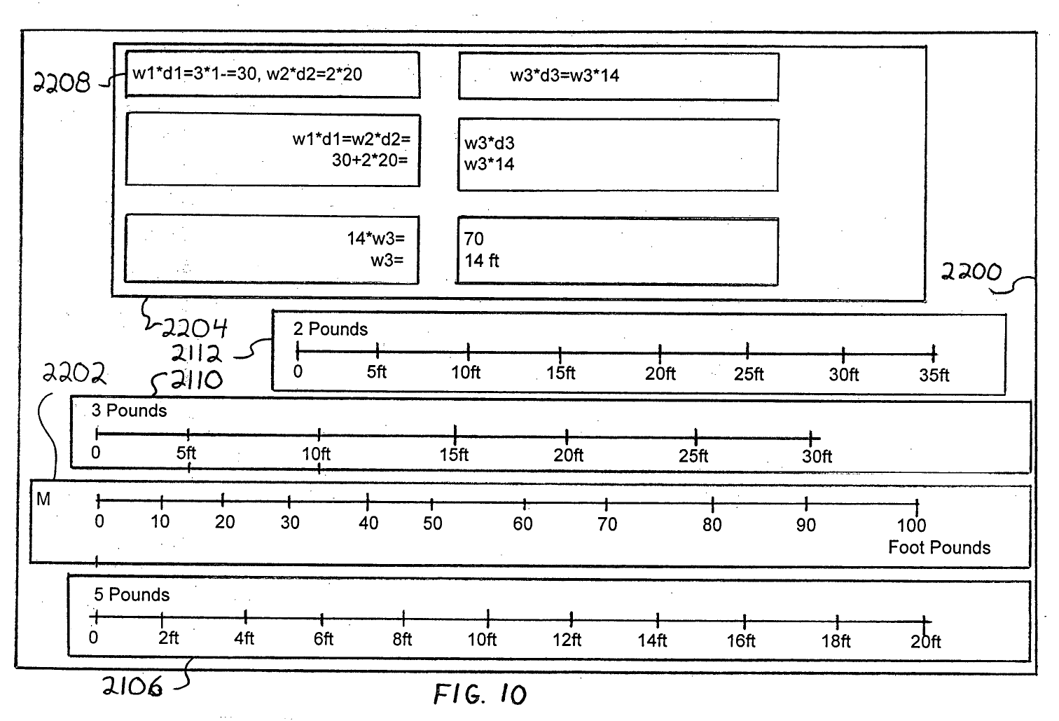

Looking a FIG. 10, there is depicted a work board 2200 having a moment arm rate line 2202 depicts a uniform incremental moment arm magnitude about a fulcrum, where the fulcrum is positioned at the zero on the moment arm rate line 2200, in which the moment arm magnitude increases from zero to one hundred foot pounds.

Turning now to FIG. 9, there is depicted a finite series of moment arm bars each having an independent predetermined rate.

An eight pound moment arm rate bar 2100 depicts the magnitude of the moment arm of an eight-pound object as measured in distance from the fulcrum, with respect to the moment arm rate line 2202 of FIG. 10. Thus, to determine the magnitude of the moment arm of the eight pound object at various distances from the fulcrum, the student simply aligns the zeros of the moment arm rate line 2202 with the zero of the eight pound moment arm rate bar 2100. The magnitude of the moment arm of the eight pound object is visually apparent at any distance along the moment arm rate line 2202.

Likewise, a seven pound moment arm rate bar 2102 depicts the magnitude of the moment arm of a seven-pound object as measured in distance from the fulcrum, with respect to the moment arm rate line 2202. The same relation exists for a six pound moment arm rate bar 2104, a five pound moment arm rate bar 2106, a four pound moment arm rate bar 2108, a three pound moment arm rate bar 2110, a two pound moment arm rate bar 2112 and a one pound moment arm rate bar 2114 with respect to weighted objects at distances from the fulcrum with respect to the moment arm rate line 2202, respectively.

The present invention pertaining to distance problems will now be described according to a predetermined example. The first example is a word problem in which a student determines the weight of an object distanced fourteen feet from the fulcrum that is required to balance a three pound object located ten feet from the fulcrum and a two pound object located twenty feet from the fulcrum.

Turning back to FIG. 10, three pound moment arm rate bar 2110 is selected and placed over the moment arm rate line 2202 so that the zeros align. At ten feet from the fulcrum, the three pound moment rate bar 2110 covers a distance of thirty foot pounds along the moment arm rate line 2202. Then, the student selects the two pound moment arm rate bar 2112 and places the same over the three pound moment arm rate bar 2110 so that the zero of the two pound moment arm rate bar 2112 aligns with the ten on the three pound moment arm rate bar 2110. The student simply looks to the twenty on the two pound moment arm rate bar 2112 and corresponding value on the moment arm rate line to determine the sum of the moment arms provide by the three and two pound objects, which in the present case is seventy foot pounds.

Now the student selects one of the remaining moment arm rate bars by trial and error to solve the problem visually. In the present case, the solution is provided by selecting the five pound moment arm rate bar 2106 and aligning its zero with the zero on the moment arm rate line 2202. At fourteen feet from the fulcrum, the five pound moment arm rate bar 2106 aligns with seventy foot pounds along the moment arm rate line.

To correlate the visual solution, the student also selects an appropriate formulae 2208 and places the same on the work board 2200 in a formula placement area 2204 depicted in FIG. 25. Then the user relates the equations to the visual solution. First moment arm formula is selected which shows the equation and solution to determine the magnitude of the three pound object at ten feet from the fulcrum. The second moment arm formula is selected and shows the equation and solution to determine the magnitude of the two pound object at twenty feet from the fulcrum. These two magnitudes are simply summed. Then, the third moment arm formula shows the solution to determine the weight of the object at fourteen feet from the fulcrum to balance the sum of the two and three pound objects. Thus, the student is able to now visualize the proper steps and proper technique for solving the problem, while touching the formulae and solution.

A pre-solved solution 2208 is depicted in a work area 2204.

MIXTURE RATES

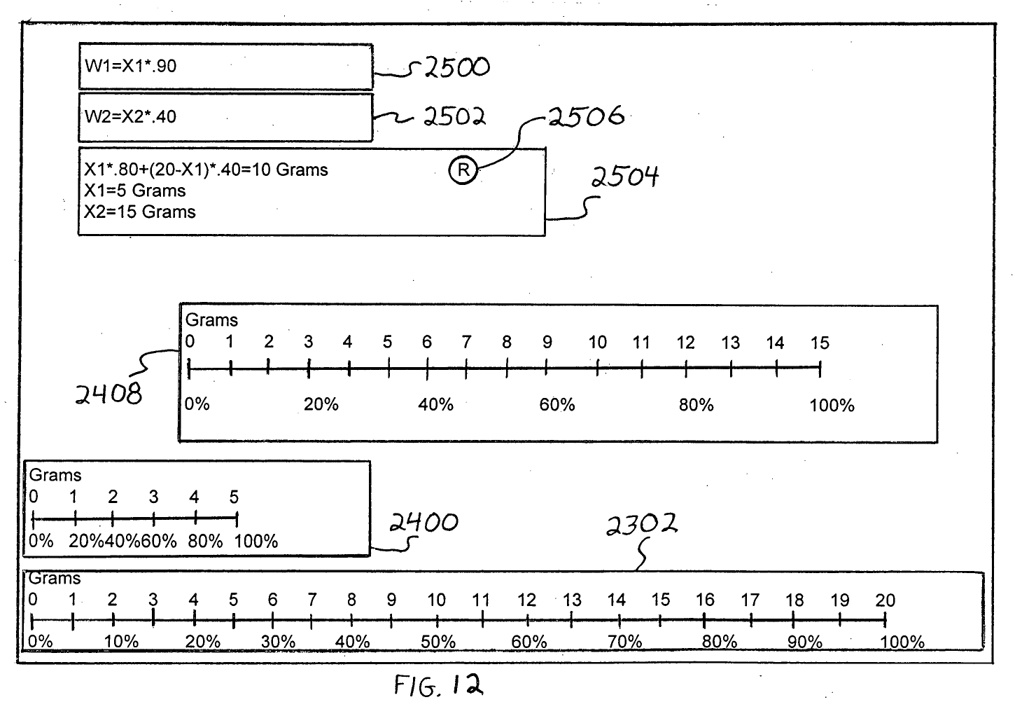

The present invention will now be shown and described as it applies to mixture rates. Looking FIG. 12, there is depicted a mixture rate work board 2300 having a weight to purity rate line 2302. For example, along the weight to purity rate line 2302 a 100% pure substance weighing twenty grams will have twenty grams of pure weight. For a substance weighing twenty grams having 50% purity of a specific substance, the pure weight of the specific substance is ten grams.

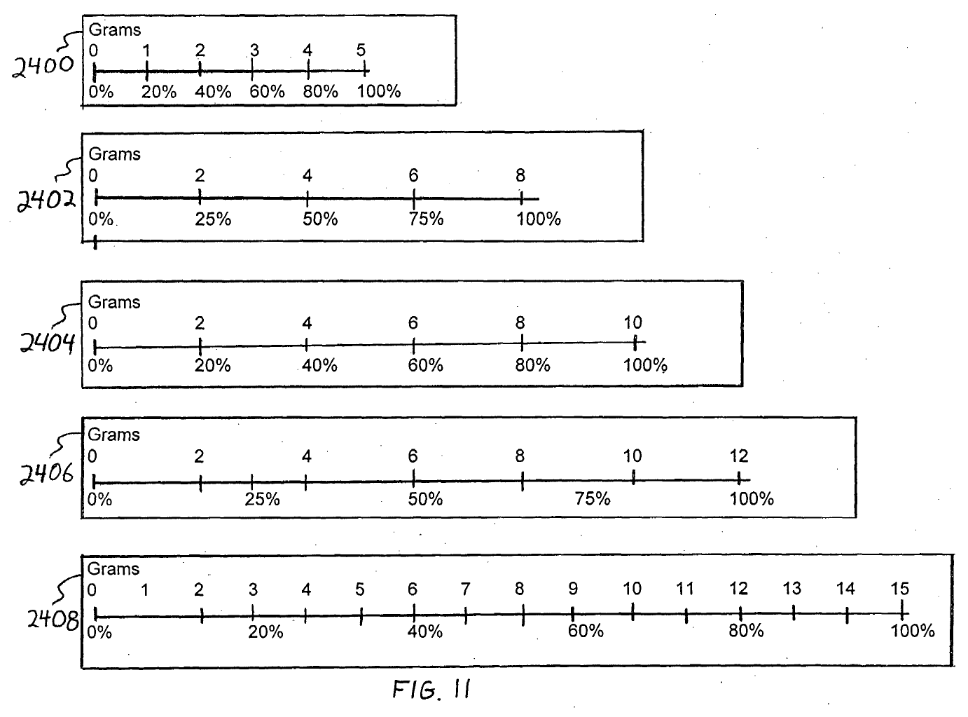

Predetermined purity rate bars are provided in FIG. 11, in which a five gram substance depicts a purity rate along a five gram purity rate bar 2400. An eight gram substance has a purity rate that is depicted along an eight gram purity rate bar 2402. A ten gram substance has a purity rate along a ten gram purity rate bar 2404. A twelve gram substance has a purity rate along a twelve gram purity rate bar 2406. Finally, for this predetermined set, a fifteen gram substance has a purity rate along a fifteen gram purity rate bar 2408.

Each of the purity rate bars allows a student to quickly visualize a pure weight of a desired specific substance in a mixed substance having a predetermined weight and purity. Thus, for example a five gram mixture having an eighty percent purity of a specific substance contains four grams of the specific substance.

The present embodiment will now be described in accordance with a specific example in which two alloys of silver are mixed, in which a first alloy contains 80% pure silver and the second alloy contains 40% silver, and the total mixture weighs twenty grams with a 50% purity of silver.

The student proceeds by trial and error to find a solution in this case. The first condition is that the mixture weighs a total of twenty grams. The student must select two compounds which together weigh twenty grams. To skip the error portion of the solution and proceed directly with the trial, the student selects the five gram purity rate bar 2400 and places the same over the mixture rate line 2302 so that the zeros align. Next, the student selects the fifteen gram purity rate bar 2408 and places the same over the five gram purity rate bar 2400 so that the zero on the fifteen gram purity rate bar 2408 aligns with the four grams or 80% of the five gram purity rate bar 2400. The solution shows that at a pure rate of 40% the fifteen gram substance combined with a pure rate of 80% of the five gram substance achieves the proper solution of 50% for a twenty gram mixture.

Turning to the formulas required to solve the problem, the student selects a first mixture formula 2500 showing how to quantify the pure weight of a specific element having 80% purity in a mixed compound, which formula is:

w1=x1*0.80 where x1 represents the total weight of the first mixed compound and w1 represents the pure weight of the specific element in the first mixed compound.

A second formula 2502 which allows the student to determine the total weight of the second mixed compound have a 40% purity of the specific element for the example is represented as follows:

w2=x2*0.40 where x2 represents the total weight of the second mixed compound and w2 represents the pure weight of the specific element in the second mixed compound. But, since x1 and x2 sum to twenty, and since w1+w2=50% purity×20 grams=10 grams; then:

x1*0.80+(20−x1)*0.40=10 grams; therefore:

x1=5 grams and x2=15 grams.

A predetermined solution 2504 is provided which shows the student the correct mathematical manipulations that are required to solve the selected problem. The predetermined solution 2504 includes a reference identifier 2506 which corresponds to a reference identifier in the selected word problem (not shown).

Generally speaking, the equations may include pre-solved solutions, thus allowing the student to visualize the solution while working the rate bars. In one embodiment, the pre-solved solutions include a reference identifier indicative of a select problem. In such a manner, the student is able to quickly select the correct solution for the select problem.

Another feature of the present invention is that a problem set, or problem sets, may be viewed by the user as a game. A particular problem set may be of a particular difficulty level, with different problem sets having differing difficulty levels. Thus, a user may time himself to determine how long it takes to move through a particular difficulty level set of problems. Two different users may race to determine who finishes a level first. As such, it becomes fun and challenging.

Further, the trial and error method makes solving word problems akin to solving a puzzle game. The eventual success in solving the problem and the failures in reaching success makes it further challenging to the user.

Therefore, the present invention acts as a bridge which not only assists a student in learning how to solve word problems but also helps provide a link between word problems and algebra equations. Student then understand how to start algebraic calculations. The present invention is both visual and tactile as the students see, touch, feel and play with the problems. The variables and their relationships become more meaningful and no longer so abstract to the students.

It is obvious to one skilled in the art that the present invention is not limited to the applications recited herein. There are many other types of algebraic problems for which the present invention is suitable. For example, the present invention may also be applied to finance problems in which initial investments, interest rates and profits are given and determined. The present invention may also be applied to problems involving simple mathematical calculations such as determining the ages of two individuals who are related in age in at least two aspects. Therefore, it is intended that the examples herein are just examples and that the present invention is also suitable for many various types of algebraic word problems.

While the applicant has endeavored to show by example a number of applications of the present invention, the examples shown and described herein should not be construed as a limitation of the applications of the present invention. Various changes and modifications, other than those described above in the preferred embodiments of the invention described herein will be apparent to those skilled in the art. While the invention has been described with respect to certain preferred embodiments and exemplifications, it is not intended to limit the scope of the invention thereby, but solely by the claims appended hereto.

What is claimed is:

1. A teaching apparatus for assisting a student's approach and understanding to solving word problems, said apparatus comprising:
at least one word problem having at least one independent variable with a predetermined known value and at least one dependent variable which is dependent on said independent variable;
a work board having an obverse surface;
a measurement line indicia disposed on the obverse surface wherein said measurement line includes a forward unit line having predetermined spaced intervals representative of a unit of measurement;
at least one movable rate bar responsive to said word problem, having predetermined rate interval indicia disposed thereon, said at least one movable rate bar adjustable in relationship to said measurement line; and
at least one movable formula responsive to said at least one word problem, wherein said at least one movable formula, includes at least one dependent and at least one independent variable.

2. The apparatus of claim 1, wherein said measurement line further includes a reverse unit line having predetermined spaced intervals representative of a single unit, wherein said reverse unit line and said forward unit line increases in magnitude in opposing directions.

3. The apparatus of claim 1, wherein said at least one measurement line is movable.

4. The apparatus of claim 3, further including at least one movable solution responsive to said at least one word problem.

5. The apparatus of claim 4, wherein said at least one movable solution includes at least one initial formula containing a background having a first pattern, at least one intermediate formula containing a background having a second pattern and at least one solution step containing a background of a third pattern.

6. The apparatus of claim 1, wherein said set of at least one movable rate bar includes a forward measurement line having equidistant spaced intervals.

7. The apparatus of claim 6, further including a reverse measurement line having equidistant spaced intervals.

8. The apparatus of claim 1, wherein said work board and said at least one movable rate bar includes a magnetic component.

9. The apparatus of claim 1, wherein said at least one movable rate bar is selected from the group consisting essentially of velocity rate bar, work rate bar, coinage rate bar, moment arm rate bar, and mixture rate bar.

10. The apparatus of claim 1, wherein said measurement line disposed on the obverse surface of said work board is selected from the group consisting essentially of distance line, work percentage line, money line, moment arm line, and mixture line.

11. The apparatus of claim 1, wherein said at least one word problem includes a unique reference indicia and wherein said at least one movable formulae further includes at least one reference indicia which correlates to said unique reference indicia of said at least one word problem.

12. A method for solving word problems having at least one independent variable and at least one dependent variable wherein said word problem defines a predetermined value for said at least one independent variable and a solution for said at least one dependent variable must be determined, said method comprising of the steps of:
selecting a word problem;
reading said word problem to identify at least one independent variable and at least one dependent variable;
selecting a measurement line that correlates with said word problem;
selecting at least one movable rate bar responsive to said word problem;
placing said at least one movable rate bar in a spatial relationship to said measurement line; and
determining the value of said at least one independent variable responsive to said placement of said at least one movable rate bars.

13. The method of claim 11, wherein the step of selecting a word problem further includes the step of selecting a word problem from the group of word problems consisting essentially of distance problems, work problems, money problems, moment arm problems, and mixture problems.

14. The method of claim 11, wherein the step of selecting at least one equation responsive to said word problem.

15. The method of claim 13, wherein the step of determining the value further includes the step of placing said at least one equation in an equation area on a work board.

16. The method of claim 11, further including the step of placing said measurement line on a work board.

17. The method of claim 13, wherein the step of selecting at least one equation responsive to said word problem further includes the step of correlating a reference identifier of said word problem with a reference identifier of said equation.

18. The method of claim 16, further including the step of selecting a predetermined solution is used to determine the at least one equation that responsive to said selected word problem.
